(19) United States
(12) Patent Application Publication
(10) Pub. No.: US 2026/0229868 A1
(43) Pub. Date: Aug. 6, 2026

(54) A CURB STONE

(71) Applicant: Hassan TABET BENSLIMANE, Zele (BE)

(72) Inventor: Hassan TABET BENSLIMANE, Zele (BE)

(21) Appl. No.: 19/151,376

(22) PCT Filed: Jan. 29, 2024
(86) PCT No.: PCT/EP2024/052023

§ 371 Date: Jul. 28, 2025

(30) Foreign Application Priority Data
Jan. 30, 2023 (EP) 23153954.5
Jun. 2, 2023 (EP) 23177044.7

(51) Int. Cl. H02G 9/06; E01C 11/22

(52) U.S. Cl. CPC H02G 9/06; E01C 11/221

(57) ABSTRACT

“A curb stone is provided with a volume, the volume having at least one recess accessible from the upper side of the curb stone. The curb stone has at least one power point retaining means for holding at least one, optionally only one power point. The power point retaining means is at least partially sunken in the at least one recess. Between the lower side of the at least one power point retaining means and the bottom of the recess, at least one void volume is provided. The curb stone has at least one drain hole adapted to conduct fluids, like rainwater, from the void volume at the bottom of the recess through the outer wall of the curb stone towards ambient.”

### FIELD OF THE INVENTION

The present invention generally relates to a powerline carrier adapted to carry powerlines on or along one or more curb stones of a curb, and to a method to provide a curb with an integrated power point or power points. The present invention in particularly relates to a curb stones of a curb, and to a method to provide a curb with an integrated power point or power points

### BACKGROUND OF THE INVENTION

Today, the use of electrically powered cars and hybrid cars is being encouraged. It is therefore important to be able to charge electric vehicles and hybrid vehicles (EVs) in an easy and easily accessible manner. Seen the currently limited capacity of the batteries in these vehicles, in particularly the hybrid vehicles, public power points for charging vehicles are to be numerous and easily accessible. Public power points are usually provided in the street scene. However, the installation of these power points is subject to a strict admission policy, the power points are often regarded as disruptive and are exposed to impact and/or damage caused by collisions with users, not only cars and trucks, but cyclists as well.

Placing a private power point at some or every house or private parking space is often simply not feasible from a spatial point of view, certainly not along municipal or urban, often busy streets. Such power points may be placed on the facade or in carports of houses. These power points are only to be used by the owner of the house. If the parking space for the car is along the street in front of this house, a cable must be laid over the footpath and, if applicable, the cycle path. These cables pose a safety risk and are often not allowed by the municipality or the city.

Moreover, installing power points, both public and private, is labour-intensive. A plinth must be cast to place the power points, which requires, among other things, an initial excavation, and a second pit is to be made to electrically connect the power points to the power distribution network.

Charging or power points being provided along the curb side of a road or parking lot, are more easily accessible, as proposed in GB2572752 and GB2597742. However, the provision of such integrated power points in curbs remains difficult to realize and is still time and work intensive, usually requiring at least the replacement of the whole curb.

### SUMMARY OF THE INVENTION

The major problem at present is that providing such power points in or on curbs is work-intensive, cumbersome and time consuming. Hence it is an objective to provide a method to install power points along curbs, even integrated in the curbs, in an easy and quick way. It is also an objective of the invention to provide means allowing such easy and quick installation.

According to a first aspect of the invention, a powerline carrier adapted to carry powerlines on one or more curb stones is provided. The powerline carrier comprises, or is an elongate volume, elongate in a longitudinal direction and having a transverse cross section adapted to be at least partially sunken in said one or more curb stones. The circumference of the transverse cross section comprises a first part adapted to contact the one or more curb stones, said section comprises a second part defining the outer side of the powerline carrier oriented away from the one or more curb stones, the powerline carrier comprises at least one housing for holding at least one, optionally only one power point, the power point being accessible at the outer side of the powerline carrier, said volume comprising at least a first entrance near or at one of the transverse sides of the volume said first entrance is adapted to receive one or more power cables at the one of the transverse sides of the volume. At least one cable or wire may be provided in said first entrance between one of the transverse sides of the volume and one or more of the at least one housing.

According to some embodiments, the first entrance may be one outer end of a first tubular channel extending in longitudinal direction at the one of the traverse sides of the volume, said first tubular channel is adapted to hold one or more power cables in the longitudinal direction of the powerline carrier, said at least one cable or wire may be provided in said first tubular channel between one of the transverse sides of the volume and one or more of the at least one housing.

Hence according to some embodiments of this first aspect of the present invention, a powerline carrier adapted to carry powerlines on one or more curb stones is provided, the powerline carrier being an elongate volume, elongate in a longitudinal direction and having a transverse cross section adapted to be partially sunken in said one or more curb stones. The circumference of the transverse cross section comprises a first part adapted to contact the one or more curb stones. The section comprises a second part defining the outer side of the powerline carrier oriented away from the one or more curb stones. The powerline carrier comprises at least one housing for holding at least one, optionally only one power point, the power point being accessible at the outer side of the powerline carrier. The volume comprises at least a first tubular channel extending in said longitudinal direction, this first tubular channel having one outer end near or at one of the transverse sides of the volume, and this first tubular channel is adapted to hold one or more power cables in the longitudinal direction of the powerline carrier. At least one cable or wire is provided in said first tubular channel between one of the transverse sides of the volume and one or more of the at least one housing. Possibly, one or more of the housings is adapted to hold a plurality of power points, between each of said housings for carrying a plurality of power points and the one of the transverse sides of the volume, at least the same number of cables or wires is provided in said first tubular channel, as the number of power points to be carried by the housing.

Possibly between one of the transverse sides of the volume and each of the at least one housing, at least one cable or wire is provided in said first tubular channel. Possibly between one of the transverse sides of the volume and each of the at least one housing, one power cable is provided in said first tubular channel. Possibly between one of the transverse sides of the volume and each of the at least one housing, one data cable is provided in said first tubular channel. Possibly between one of the transverse sides of the volume and each of the at least one housing, one power cable and one data cable is provided in said first tubular channel. Possibly between one of the transverse sides of the volume and each of the at least one housing, one cable is provided in said first tubular channel, said cable comprises one or more data carrying conductors and one or more, such as 3, 4, or 5 current conductors.

According to some embodiments, for each of the at least one housings, a pass through opening for conducting at least one power cable between the first tubular channel and the at least one housing may be provided, the at least one cable or wire being provided in said pass through opening.

The transverse cross section is a section according to a plane perpendicular to the longitudinal direction. A longitudinal cross section is a section according to a plane parallel to the longitudinal direction.

The transverse cross section is substantially identical along the longitudinal direction in the zones of the powerline carrier where a housing for holding a power point is absent.

The power line carrier may comprise more than one housing for holding a power point such as 2, 3, 4, 5, 6, 7, 8, 9, 10 or more housing for holding a power point. Optionally the housing may be designed to house more than one power point, e.g. 2, 3, 4 or more power points. Preferably the power line carrier comprises one to seven housings, each housing adapted to hold a power point.

Possibly the housings may be provided in pairs, one adjacent to the other in longitudinal direction. The housings may have an opening to receive a plug from a user. The openings may be oriented away from each other in longitudinal direction or may both face the same lateral side of the powerline carrier.

According to some embodiments, the at least one cables or wires may be pull wires in said first tubular channel.

According to some embodiments, at least one cables or wires may be power cables in said first tubular channel.

Preferably one power cable per housing, and possibly one power cable per power point which may be housed in the housing, is provided.

According to some embodiments, the powerline carrier may comprise one or more data cables in said first tubular channel.

According to some embodiments, the powerline carrier may comprise M housings for holding a power point, M being an integer equal or more than 1, said powerline carrier comprises M data cables in said first tubular channel.

According to some embodiments, the powerline carrier may comprise N housings for holding a power point, N being an integer equal or more than 1, said powerline carrier comprises N power cables in said first tubular channel.

Each power cable may comprise a plurality of current conductors, each adapted to carry a phase of the alternating current or direct current top the power point. As an example, each of the power cables may comprise 5 current conductors, 3 conductors being so-called live conductors to carry a phase of the current, cone conductor to carry or being the neutral conductor, and one conductor being the earth conductor. Each power cable may further comprise one or a plurality of data carrying conductors, adapted to carry data from or to the housing or the power point. Each power cable may be a power cable in which the current and possibly the data carriers, each insulated, are carried in a substantially circular polymer jacket. Alternatively the power cable in which the current and possibly the data carriers, each insulated, are carried in a substantially rectangular polymer jacket, in which the current carriers may be organised one adjacent to the other in a plane, the plane being parallel to the long side of the rectangular cross section. The data carriers may also be organised one adjacent to the other in a plane, or may be provided as a strand of mutually insulated data carriers, said strand being substantially parallel to the data carriers.

According to some embodiments, the power cables may comprise a substantially rectangular outer circumference, the power cables being provided stacked in the first tubular channel.

The first tubular channel may have a substantially rectangular cross section, two parallel sides of the rectangular cross section being substantially parallel to the long side of the substantially rectangular outer circumference of the power cables. These two parallel sides of the rectangular cross section may be oriented such that they are substantially horizontal when the powerline carrier is in use. Understanding the second part of the circumference of the traverse cross section of the powerline carrier, defining the outer side of the powerline carrier oriented away from the one or more curb stones, being understood as defining the top of the powerline carrier, the order of the power cables being layered hence stacked in the first tubular channel, is such that the power cable which is provided to the first housing closest to the one of the transverse sides of the volume, is the uppermost power cables in the stack of power cables. For each subsequent housing from this first housing, the power cable which is provided to this subsequent housing, is the subsequent power cable downwards in the stack of power cables away from the top of the powerline carrier.

According to some embodiments, the powerline carrier or carriers, at the end of the powerline present at the housing, may be provided with one or more plugs adapted to plug into a power point.

According to some embodiments, the powerline carrier may comprise a power point in at least one of the at least one housing for holding a power point, optionally holding one power point in each of the at least one housing for holding a power point.

According to some embodiments, the power point is electrically coupled to one of the power cables in the first tubular channel. This may be done by means of the plug or plugs provided to the end of the power cable, being inserted in the appropriate sockets of the power point or power points inserted in the housing.

According to some embodiments, the at least one housing for holding a power point may be provided with a closing lid, optionally hingedly connected to the housing, the closing lid being adapted to liquid tightly close the housing from the environment at the outer side of the powerline carrier.

According to some embodiments, between the housing and the closing lid, a lock may be provided, preventing to open the closing lid without unlocking the lock.

The lock may be a key operated lock, an electrically operated lock or any suitable type of lock.

The transverse cross section, adapted to be partially sunken in said one or more curb stones, may be substantially rectangular, with a surface serving as the surface in which the housings for the power point are present and being referred to a s the top surface, is slightly curved. The first part may be the side of the rectangular cross section opposite to this top surface, together with a part of, or the complete adjacent upstanding sides. Hence the second part is the top surface.

The powerline carrier may comprise a first part, adapted to be sunken in the curb stone or stones, which comprises at least two pairs of a first and a second segment.

According to some embodiments, the first part may comprise at least two pairs of a first and a second segment, the segments of said pairs of segments being adapted to be brought in contact with the one or more curb stones, for each of said pairs of segments, the first and second segment form the legs of an angle oriented outwards the volume of the powerline carrier, which angle is equal or more than 90° and less than 180°.

The transverse cross section may have a mushroom shape with a stem oriented down, the stem possibly ending at a point. The second segment may be the side of the stem, while the lower side of the cap provides the first segments.

An angle oriented outwards the volume of the powerline carrier, hereinafter also referred to as outer angle, means the angle formed at the side of the legs, which does not comprise a part of, hence is oriented away from the volume.

The outer angle between the first and second segment, is preferably in the range of 90°°to 180°.

The two first segments preferably are parallel, more preferably coplanar.

According to some embodiments, for the transverse cross section, the two lines, each line coinciding with one to the first segments of the at least two pairs of a first and a second segment, divide the cross section in an upper portion delimited by these two lines and the second part of the section, and a lower portion at least partially delimited by these two lines and the second segments of the at least two pairs of a first and a second segment, said first tubular channel being located in the lower portion.

According to some embodiments, for the transverse cross section, the two lines, each line coinciding with one to the first segments of the at least two pairs of a first and a second segment, divide the cross section in an upper portion delimited by these two lines and the second part of the section, and a lower portion at least partially delimited by these two lines and the second segments of the at least two pairs of a first and a second segment, said housings of said at least one housing for holding a power point being located in the lower portion.

Possibly, each housing is provided with one or more tell-tale lights. The tell-tale lights may inform the environment of the status of power point housed in the housing, like available for providing power, unavailable for providing power, defect, locked, unlocked, and many more. The combination of switched or unswitched tell-tale lights may provide the information.

The housing may be provided with illumination, in order to assist the user to insert a power plug in the power point. The power point may comprise a socket electrically couplable to a power plug.

Possibly, each housing may be provided with a code, like a QR code or alike, or with a holder to hold a code; like a QR code or alike. This code may provide the user with suitable information on a data providing means, like a smartphone or alike.

This code, like a QR code may be used to identify the power point, and to enable to switch on or off the power supply to this power point, and/or to lock or unlock the lock of this power point, e.g. via remote control or via a non-wired connection to a control device controlling the status and power supply to one or more power points.

According to some embodiments, for the transverse cross section, the two lines, each line coinciding with one to the second segments of the at least two pairs of a first and a second segment, are non-parallel, the second segments intersecting at a bottom point of the cross section.

As such, from the angles of the first and second segments towards the bottom point, a triangular wedge is defined. This has the advantage that for applying the powerline carrier to existing curb stones, the only a wedge shaped insertion is to be provided on the top side of the curb stones. The wedge is preferable identical to the wedge shape defined by the second segments of the pairs of segments, such the powerline carrier smoothly can be laid and inserted in the wedge in the curb stones. Obviously a connection between the curb stone wedge and the powerline carrier may be provided, like a glue or an adhesive. The wedge in the curb stones, being triangular shaped, may be grinded in the curb stones.

Alternatively from the angles of the first and second segments towards the bottom point, a trapezoidal wedge may be defined, by providing a lower segment delimiting the second segments of the pairs of segments at their side pointing away from the angles made with the first segments of the pairs of segments.

The angle between the two second segments, measured at the intersection of the two segments, possibly at the bottom point is preferably in the range of 0° to 120°, e.g. 0°to 90°.

Possibly, along the second segments towards the bottom point or the lower segment, barbs may be provided having their top oriented towards the bottom point or the lower segment. These barbs may prevent the powerline carrier to be easily pulled out of the wedge made in the curb stones once inserted.

According to some embodiments, the second part defining the outer side of the powerline carrier oriented away from the one or more curb stones may be a curved outer side.

According to some embodiments, the power line carrier may comprise polymeric material, such as natural or artificial and optionally recycled rubber.

Optionally the polymeric material comprises reinforcing elements, like reinforcing fibers or sheets, e.g. metal wire sheets or glass fibers of glass fiber woven sheets.

Possibly the first tubular channel is provided by a tubular element. Possibly the powerline carrier comprises more than one tubular channel.

Possibly the powerline carrier is provided with bolt openings along the lateral sides of the powerline carrier. This to allow the powerline carrier to be bolted to the curb stone or curb stones. These bolt openings may extend thought the volume of the powerline carrier from the second part defining the outer side of the powerline carrier oriented away from the one or more curb stones through the first segment of the first part.

According to some embodiments, the powerline carrier may comprise at one longitudinal end one or more sockets, each adapted to couple to one or more of the powerlines to be carried, and at the other longitudinal end one or more plugs, each adapted to couple to one or more of the powerlines to be carried and adapted to be electrically coupled the one or more sockets of an adjacent powerline carrier.

According to some embodiments, the first part of the circumference of said transverse cross section may comprise at least one stuffing box for holding a seal or joint to be provided between the first part and the surface of the curb stone or stones.

According to some embodiments, the powerline carrier may comprise is adapted to be rolled up on a coil, said coil preferably having a diameter less than 10 m and possibly having a diameter of more than 1 m.

The length of a powerline carrier according to the invention is preferably more than 10 m, such as in the range of 10 m to 50 m.

Alternatively, the powerline carrier is provided as a strip, such as a substantially flat strip, preferably having a length up to 14 m, e.g. in the range of 1 m to 13.6 m, more preferably in the range of 10 m to 13.5 m.

According to some embodiments, the powerline carrier comprises, even may consists of, an upper and a lower, mutually separatable piece, separatable along a surface said surface for each transverse cross section along the longitudinal direction, defining the two lines, each line coinciding with one to the first segments of the at least two pairs of a first and a second segment, divide the cross section in an upper portion delimited by these two lines and the second part of the section, and a lower portion at least partially delimited by these two lines and the second segments of the at least two pairs of a first and a second segment, said first tubular channel being located in the lower portion.

The upper and a lower, mutually separatable piece may be joined by adhesive of glue, thereby forming the powerline carrier. Providing the powerline carrier in two pieces facilitate an easier installation of the powerline carrier on existing or freshly mounted or casted curb stones or curbs.

A powerline carrier may comprise an upper and a lower separatable portions, together forming the powerline carrier. The lower separatable portion provides at least piece of the first part of the transverse cross section adapted to be partially sunken in said one or more curb stones. The upper separatable portion provides the first part of the transverse cross section, and optionally also a piece of the first part of the transverse cross section adapted to be partially sunken in said one or more curb stones. The lower separatable portion comprises said at least a first tubular channel, while the upper separatable portion comprises said at least one housing for holding at least one, optionally only one power point. So according to a second aspect of the invention, a kit of parts is provided. the kit comprises an upper and a lower separatable portions, together forming the powerline carrier according to the first aspect of the present invention.

The upper and lower portion may be made separate and joined once provided. The upper and lower portion may be handled separately and be joined when the lower portion has been mounted on or in the curb stone or curb stones.

The coupling of the upper and a lower mutually separatable portion may be provided by any suitable means to join the two portions. The upper portion may comprise one of the male or female part of a snap lock system, the lower portion comprising the other of the male or female part of a snap lock system.

One or both of the touching surfaces of the upper and a lower mutually separatable portions may comprise a stuffing box to receive a seal between the upper and lower portion.

According to a third aspect of the invention, a curb stone insert is provided, the curb stone insert being an elongate volume, elongate in a longitudinal direction and having a transverse cross section. The curb stone insert is adapted to be partially sunken in said one or more curb stones. The circumference of said transverse cross section comprises a least a first part adapted to contact the one or more curb stones, the volume comprising at least a first tubular channel extending in said longitudinal direction, said first tubular channel having one outer end near or at one of the transverse sides of the volume, said first tubular channel is adapted to hold one or more power cables in the longitudinal direction of the powerline carrier, at least one cable or wire is provided in said first tubular channel. This curb stone insert may provide the first part adapted to contact the one or more curb stones of the circumference of the transverse cross section of a powerline carrier according to the first aspect of the invention, and/or the lower part of a kit of parts according to the second aspect of the invention. The features of the first part adapted to contact the one or more curb stones of the circumference of the transverse cross section of a powerline carrier according to the first aspect of the invention thus may apply for this curb stone insert according to the third aspect of the invention.

According to a fourth aspect of the invention, a powerline carrier adapted to carry powerlines on one or more curb stones is provided, for which the powerline carrier is an elongate volume, elongate in a longitudinal direction and having a transverse cross section adapted to be at least partially sunken in said one or more curb stones, the circumference of said transverse cross section comprises a first part adapted to contact the one or more curb stones, said section comprises a second part defining the outer side of the powerline carrier oriented away from the one or more curb stones, the powerline carrier comprises at least one housing for holding at least one, optionally only one power point, the power point being accessible at the outer side of the powerline carrier, said volume comprising at least a first entrance near or at one of the transverse sides of the volume said first entrance is adapted to receive one or more power cables at the one of the transverse sides of the volume. At least one cable or wire may be provided in said first entrance between one of the transverse sides of the volume and one or more of the at least one housing. The elongate volume comprises a box in which at least one, or a plurality of housings for holding at least one, optionally only one power point being provided, said first entrance is opening in the box at a lateral wall of the box.

A lateral wall is a wall which is perpendicular to the longitudinal direction and present at the transverse side of the volume.

According to some embodiments, some or all of the at least one, or a plurality of housings may be rotatable in said box between at least a first position and a second position, said housing being in the first rotational position being adapted to provide the power point accessible at the outer side of the powerline carrier, said housing being in the second rotational position being adapted to hide the power point from the outer side of the powerline carrier.

Preferably when the housing or housings are in their first rotational position, the power point or power points are oriented non horizontal, more preferred substantially vertical.

According to some embodiments, the axis or axes of rotation of the rotational housing or housings may be perpendicular to the longitudinal direction.

The elongate volume may hold more than one, e.g. two housings, one adjacent to the other. Each of the housings may hold one or more than one power point. The two housings may be rotatable each around an axis, which axes are parallel one to the other. The first housing may be rotatable in clockwise direction around its axis, the other being rotatable counterclockwise around its axis. The two housings may be rotatable around its respective axis, such the rotations are directed towards each other.

Each housing may comprise a cap or cap fitting, such the power point, when exposed to the ambient, is sheltered from rainwater, snow or hail which may fall into the power point.

According to some embodiments, the at least first entrance may be provided at one of the transverse sides of the volume

According to some embodiments, the at least first entrance may be provided near one of the transverse sides of the volume in the bottom of the volume

According to some embodiments, the volume comprises at least a flange for contacting the top side of the curb stone when the box may be at least partially sunken in said one or more curb stones.

According to some embodiments, the box may be a polymeric, composite or metal, such as stainless steel box.

The powerline carriers according to this aspect of the invention may be used in combination with the curb stone coverups according to the invention.

According to a fourth aspect of the invention, a curb stone adapted to receive at least one powerline carrier according to the fourth aspect of the invention is provided. This curb stone comprises a recess for having the elongate volume of the at least one powerline carrier to be at least partially sunken in recess.

According to some embodiments, the curb stone may be adapted to receive more than one powerline carrier according to the fourth aspect of the invention, wherein the curb stone may comprise a recess for having the elongate volumes of the more than one powerline carriers to be at least partially sunken in recess.

According to some embodiments, the curb stone may have traverse sides, the curb stone comprising a first tubular channel, extending, preferably in longitudinal direction, between the one of the traverse sides of the curb stone and the recess, said first tubular channel is adapted to hold one or more power cables.

According to some embodiments, the curb stone may have a cavity oriented inwards the curb stone and extending from the top side of the curb stone at least up to the outer end of the first tubular channel present at the one of the traverse sides.

According to some embodiments, the curb stone may comprise at least one drain hole adapted to conduct fluids, like rainwater, from the recess receiving the housing or housings through the outer wall of the curb stone towards ambient.

The dimensions of said curb stone may vary in order to be aligned or fit to replace curb stones in an existing curb. In the curb stones with different dimensions, the recess may be of uniform dimension in order to allow the same powerline carriers to be at least partially, optionally fully sunken in the recess. Possibly the recess is wide enough to receive two or more, optionally identical powerline carriers one adjacent to the other in a direction parallel to the curb of which the curb stone is to be or become part of. Each of these powerline carriers may comprise more than one housing with one or more power points each, although preferably two powerline carriers, each holding one housing are provided. These powerline carriers may be identical, but placed in opposite direction. When the powerline carriers hold a rotatable housing, placing them in opposite direction has the advantage that the housings rotate in opposite direction when seen from the same side of the curb stone, one rotating clockwise, the other rotating counterclockwise. As such, using the same powerline carriers, two mutually opposed power points may be provided, having their direction of access opposite one to the other.

A rotation system to rotate the housing or housings may be provided. This rotating system may comprise a controllable motor, e.g. an electrically driven motor to provide the rotation, or may comprise as an example a gas pump to drive the rotation. Any other suitable rotation system may be installed and used.

According to a sixth aspect of the invention, a curb stone addon is provided, the curb stone addon being an elongate volume, elongate in a longitudinal direction and having a transverse cross section. The curb stone addon is adapted to be added on the top surface of one or more curb stones. The circumference of said transverse cross section comprises a part defining the outer side of the curb stone addon oriented away from the one or more curb stones. The curb stone addon comprises at least one housing for holding at least one, optionally only one power point, the power point being accessible at the outer side of the curb stone addon. This curb stone addon may provide the second part of the transverse cross section of a powerline carrier according to the first aspect of the invention, and/or the upper part of a kit of parts according to the second aspect of the invention. The features of the second part of the circumference of the transverse cross section of a powerline carrier according to the first aspect of the invention thus may apply for this curb stone addon according to the fourth aspect of the invention.

According to a seventh aspect of the invention, a curb stone coverup is provided, the curb stone coverup being an elongate volume, elongate in a longitudinal direction and having a transverse cross section. The curb stone coverup is adapted to be added on the top surface of one or more curb stones. The circumference of said transverse cross section comprises a part defining the outer side of the curb stone coverup oriented away from the one or more curb stones. The curb stone coverup may have the same transverse cross section of a curb stone addon according to the fourth aspect of the invention, while lacking, hence being free of, the housings for housing power points. This curb stone coverup may be used in combination with a curb stone insert according to the third aspect of the invention, instead of a curb stone addon. This curb stone coverup may be coupled to the curb stone insert in the same or a similar way as the curb stone addons, hence these features of the curb stone addons may apply to the curb stone coverup as well.

Combining one or more curb stone inserts with one, or even more, curb stone addons and one or more curb stone coverups, provide the possibility to provide power points along a length of a curb, which length is longer than the length of one curb stone addon. Alternating curb stone addons and curb stone coverups, provide more freedom to define the position of power points along the length of a curb.

This curb stone coverups may be used in combination with a curb stone according to the fourth aspect of the invention.

Hence according to an eighth embodiment of the present invention, a kit of parts is provided, the kit of parts comprises at least one, possibly more than one, curb stone inserts according to the third aspect of the invention, at least one, and possibly more than one, curb stone addons according the fourth aspect of the invention, and optionally one or more curb stone coverups according the fifth aspect of the invention. Possibly, the kit of parts may further comprise bend element or elements in order to allow the power lines and optionally the tubular channel or channels, and hence the power lines, to bend away from the elongate direction e.g. towards a side of the road or field from which the curb is part of. Possibly, the kit of parts may further comprise end piece element or elements to others close the tubular channel at a transverse side when this channel debouches at one or both transverse sides of the powerline carrier.

According to a ninth aspect of the invention, a method to provide integrated power points to a curb is provided. The method comprises the steps of
Providing a curb comprising one or more curb stones having a wedge in the visible surface of the curb stone or curb stones;
Providing a powerline carrier according to the first aspect of the invention;
Coupling the powerline carrier to the one or more curb stones.

The latter step may include
a) Inserting the first parts of the transverse cross section of a powerline carrier in the wedge provided in the one or more curb stones;
b) providing at least one housing for holding a power point with a power point;
c) providing one or more power lines in the at least first tubular channel
d) electrically coupling a power point or power points to the one or more power lines;
e) inserting a power point or power points in one or more housings.

Possibly the steps b, c, d and e are done prior to step a. Alternatively the step a is done prior to the steps b, c, d and e, b, c, d and e done in this order.

Possibly the steps c, d and e are done prior to step a, which on its turn is done prior to step b. Alternatively the step a is done prior to the steps b.

According to some embodiments, when the powerline carrier comprises, or even consists of an upper and a lower, mutually separatable piece, coupling the powerline carrier to the one or more curb stones may comprise
a) 1.) Inserting the lower part of the powerline carrier in the wedge provided in the one or more curb stones;
a) 2.) Connecting the upper part of the powerline to the lower part of the powerline carrier;
b) providing at least one housing for holding a power point with a power point;
c) providing one or more power lines in the at least first tubular channel;
d) electrically coupling the power point or power points to the one or more power lines and inserting the power point or power points in the housings.

Optionally step a1 comprises adhering the lower part of the powerline carrier to the curb stone or curb stones in the wedge being provided. Optionally step c is done after step a1 and before step a2.

Providing a curb comprising one or more curb stones having a wedge in the visible surface of the curb stone or curb stones may comprise grinding or milling a wedge in the one or more curb stones of an installed, e.g. existing curb. Alternatively, one or more curb stones having a wedge in the visible surface of the curb stone or curb stones are provided, and installed as a curb, prior to the provision of the powerline carrier. Alternatively, one or more curb stones having a wedge in the visible surface of the curb stone or curb stones are casted in situ, thereby providing the curb, prior to the provision of the powerline carrier. Alternatively, one or more curb stones having a visible surface of the curb stone or curb stones are casted in situ, after which a wedge is made, like grinded or cut, in the visible surface of the curb stone or curb stones, thereby providing the curb, prior to the provision of the powerline carrier.

The power lines are to be electrically coupled to the power grid. A distribution means, like a distribution box may be provided to couple the power lines to the power grid. If provided, the data cables may also be connected to a control means, thereby allowing to control, based amongst others upon the data obtained via the data cables, the distribution of electrical power to one or more of the power points.

The distribution means may comprise the switches to switch the power to or from each of the power cables present in the powerline carrier once installed. The distribution means may hold the processing unit to amongst other control the status of the power points connected to the distribution means, to control the locking and unlocking of the locks on the power points if applicable, and many more. The processing unit may comprise a measuring unit to measure the power of current consumed by each of the power points. The distribution means may also comprise the communication unit to communicate information, like status of the power points, the amount of current consumed over a certain period in time, and alike, with an external power provider, selling the current consumed at the power points to customers charging their vehicle at one of the power points.

Hence, a method to provide integrated power points to a curb is provided. The method comprises the steps of
Providing a curb comprising one or more curb stones according to the fifth aspect of the invention;
Providing at least one powerline carrier according to the fourth aspect of the invention;
at least partially sinking said at least one powerline carrier in at least one of said one or more curb stones.

According to a tenth aspect of the invention, a curb stone is provided, the curb stone having a volume, said volume having at least one recess accessible from the upper side of the curb stone. The curb stone comprises at least one power point retaining means for holding at least one, optionally only one power point, said power point retaining means being at least partially sunken in said at least one recess, between the lower side of said at least one power point retaining means and the bottom of said recess, at least one void volume is provided. The curb stone comprises at least one drain hole adapted to conduct fluids, like rainwater, from the void volume at the bottom of the recess through the outer wall of the curb stone out of said volume.

The curb stone may comprise more than one, e.g. 2, 3 or 4 recesses, all similar or identical. In each of the one or more recesses, at least one, but possibly more than one, like 2, 3 or 4 power point retaining means may be inserted. Each of these power point retaining means may hold at least one, optionally only one, but possibly more than one, like 2, 3 or 4 power points. The power point retaining means may be partially or fully sunken in the recess. The power point retaining means may comprise a rim extending sideways from the side wall of the power point retaining means, and being adapted to contact the outer wall of the volume adjacent the recess.

The drain hole may be adapted to conduct fluids, like rainwater, from the void volume at the bottom of the recess through the outer wall of the curb stone to or into the adjacent drain hole of the adjacent curb stone according to the invention, to the ambient, to the sewer by means of a pipe or similar fluid conducting means, to a reservoir, like an underground reservoir or a similar fluid containing unit, to a water infiltration system comparing piping, reservoirs and or any similar infiltration elements, or any other system to divert water from the curb stone.

The power point retaining means may also be a housing, in which the power point is held. It may as well be any means, like a frame or similar, which can hold the power point in place in the recess. The housing or the said at least one power point retaining means may have the shape of a box, which box is made from a polymeric material, composite material, or metal, such as a stainless steel box.

The curb stone hence comprises a volume or body in which a recess is provided. This volume may be provided from concrete, composite material or even may be from polymer material, such as rigid polymer material.

According to some embodiments, the at least one power point retaining means may have at least one opening at the lower side of the said at least one power point retaining means.

This opening is preferably provided at the lowest point of the said at least one power point retaining means when installed in the recess. Optionally more than one opening is provided at the lower side of the said at least one power point retaining means. Even more preferred, the lower side of the said at least one power point retaining means is substantially completely open.

According to some embodiments, the curb stone further may comprise a first tubular channel adapted to hold one or more power cables between the outer side of the volume and said recess.

According to some embodiments, the first tubular channel may be a channel positioned adjacent or under the void volume at the bottom of the recess.

The first tubular channel may have a circular, polygonal oval or any other suitable traverse cross section. Rectangular, square, oval or circular cross sections are preferred.

The first tubular channel may have at least first entrance provided at one of the transverse sides of the volume. More preferred, the first tubular channel may have at least a first and a second entrance, each of the transverse sides of the volume being provided with one of these entrances. Possibly this first tubular channel passes near the bottom of the volume, and/or passes from the one transverse side to the other transverse ide of the volume.

Preferably this first tubular channel may comprise more than one, such as 2, 3, 4, 5, 6 or even more power cables. Possibly this first tubular channel may comprise also one or more data cables.

The first tubular channel may have a branch or opening towards said recess to pass one or more power cables and/or data cables from the first tubular channel to said recess. As such the connection between a means at the outer ambient of the volume via these one or more power cables and/or data cables, optionally further being coupled to a power station or power supply, and the power point or points may be provided.

Hence the volume may comprise at least a first entrance near or at one of the transverse sides of the volume, said first entrance is adapted to receive one or more power cables at the one of the transverse sides of the volume. This first tubular channel may have a second entrance. Each of the transverse sides of the volume maybe provided with one of these two entrances. These two entrances may be positioned such that the first entrance of a first curb stone according to the invention, is aligned with the second entrance of a second curb stone according to the invention, when being installed. When the curb stones are part of a curb, one or more power cables and/or data cables may pass through the first tubular channel of one curb stone, towards first tubular channel of the adjacent curb stone, and so on. As such a pass way for one or more power cables and/or data cables between a plurality of mutually adjacent curb stones may be provided.

According to some embodiments, the volume of the curb stone may be an elongate volume, elongate in a longitudinal direction

According to some embodiments, the at least one recess may be an elongate recess, elongate in said longitudinal direction of said volume.

Preferably the recess is cuboid or has a substantially polygonal transverse cross section. Most preferably the upper side of the volume may be substantially parallel to the ambient surface upon installation of the curb stone.

The volume of the curb stone has a transverse cross section, substantially polygonal. The top side of the transverse cross section is substantial flat or slightly inclined to the horizontal when the curb stone is installed.

According to some embodiments, at least a first and a second drain hole may be provided, one at each traverse side of the volume.

According to some embodiments, at least a first drain hole may be provided, at one lateral side of the volume.

Possibly at least a first and a second drain hole is provided, one at each of the lateral sides of the volume.

According to some embodiments, under the lower side of said at least one power point retaining means and spaced apart from the bottom of said recess, a water permeable object retaining surface may be provided

According to some embodiments, the water permeable object retaining surface may be provided by a metal or polymeric grid, perforated plate or a filter system comprising a water permeable envelope, filled with solid objects, such as crushed stone, biodegradable objects or alike.

This water permeable envelope may itself be provided from metal or polymer grid.

As such only the water of the water and dirt stream, seeping into the recess, passes at the bottom of the power point retaining means through this water permeable object retaining surface into the void volume, where the water may be evacuated by the at least one, and possibly more than one drain holes. The dirt is trapped and may be taken out of the recess upon cleaning the curb stones recess. The water permeable object retaining surface may work like a drainage layer. The water permeable object retaining surface may be provided as tiles or as separate parts, and preferably are also removeable out of the recess.

The at least one power point retaining means may be removably mounted in the recess, in order to be taken out from the recess during cleaning of the recess.

Hence the curb stone may comprise a second tubular channel adapted to remove the water from the recess to the ambient of the curb stone. This second channel may be a separate channel being fluidicly coupled to the recess, preferably the recesses bottom, or may be provided by the bottom of the recess, two lateral upstanding walls and the water permeable object at the top side of the second tubular channel.

Hence the volume may comprise at least a first drain hole at one of the transverse sides of the volume, and a second drain hole at the opposite transverse sides of the volume. These two drain holes may be positioned such that the first drain hole of a first curb stone according to the invention, is aligned with the second drain hole of a second curb stone according to the invention, when being installed. When the curb stones are part of a curb, water from the void volume of a first curb stone of this curb, may pass towards the void volume of the adjacent curb stone, and so on. As such a pass way for one drain water between a plurality of mutually adjacent curb stones may be provided.

According to some embodiments, the curb stone further comprises the curb stone may comprise a second tubular channel extending between two mutually opposite sides of the volume of the cube stone, preferably the traverse sides of the volume, said second tubular channel providing two drain holes adapted to conduct fluids, like rainwater, from the void volume at the bottom of the recess through the outer wall of the curb stone towards ambient

In the curb stone, in the at least one recess, at least one, and possibly plurality of power point retaining means for each holding at least one, optionally only one power point may be provided. Two or more power point retaining means may be installed in one recess, the power point retaining means being adjacent one to the other in longitudinal direction of the curb stone.

The power point retaining means may be identical or similar to the housing for holding at least one, optionally only one power point of the powerline carrier fourth aspect of the invention.

According to some embodiments, the at least one power point may be rotatable in said power point retaining means between at least a first position and a second position, said power point when being in the first rotational position, is adapted to provide the power point accessible at the outer side of the curb stone, said power point being in the second rotational position, said the power point being hidden from access from the outer side of the curb stone.

Optionally, when said power point being in the second rotational position, this power point is hidden from the outer side of the curb stone, even optionally being sunken completely in the recess of the curb stone.

The axis or axes of rotation of the rotational power point may be perpendicular to the longitudinal direction of the curb stone. The axis or axes of rotation of the rotational power point may be parallel to the upper side of the curb stone.

According to some embodiments, the axis or axes of rotation of the rotational power point may be perpendicular to the longitudinal direction of the curb stone and parallel to the upper side of the curb stone.

According to some embodiments, the power point retaining means may comprise at least a flange for contacting the top side of the curb stone when the power point retaining means is at least partially sunken in said recess.

According to an eleventh aspect of the invention, a curb stone according to the tenth aspect of the invention is used to provide integrated power points to a curb.

The curb stones may be mounted or positioned one adjacent and preferably in contact to each other. The curb stones may be mounted or positioned such the drain holes communicate one to the other and form a fluid, like water, diverting means to conduct the fluid, like rainwater to a system to divert water from the curb, e.g. to the ambient or to the gutter or to the sewer by means of a pipe or similar fluid conducting means, to a reservoir, like an underground reservoir or a similar fluid containing unit, to a water infiltration system comparing piping, reservoirs and or any similar infiltration elements, or any other system to divert water from the curb.

According to a twelfth aspect of the invention, a curb is provided, which curb comprising a plurality of curb stones according to the tenth aspect of the invention.

Optionally the curb comprises or even consists of curb stones according to the tenth aspect of the invention, being mounted one adjacent the other.

The curb stones according to the tenth aspect of the invention may be combined with additional curb stones having a volume or body in which at least a first tubular channel is provided, this channel having entrances being adapted to receive one or more power cables at both the transverse sides of the volume. These two entrances may be positioned such that the first entrance of a first curb stone according to the invention, is aligned with one of the entrances of such curb stone, when being installed. When the curb stones are part of a curb in which also curb stones according to the tenth aspect of the invention are used, one or more power cables and/or data cables may pass through the first tubular channel of one curb stone, towards first tubular channel of the adjacent curb stone, and so on, some curb stones being curb stones according o the tenth aspect of the invention. As such a pass way for one or more power cables and/or data cables between a plurality of mutually adjacent curb stones may be provided. The additional curb stones may comprise a second tubular channel as well. This second tubular channel is adapted to conduct the water from the recess, this separate channel having two openings, one at each of the two lateral upstanding walls of this additional curb stone.

When curb stones according to the tenth aspect of the invention are used, which curb stones have a volume comprising at least a first drain hole at one of the transverse sides of the volume, and a second drain hole at the opposite transverse sides of the volume the first drain hole of a first curb stone according to the invention, is aligned with one of the openings of such additional curb stone. As such a pass way for drain water between a plurality of mutually adjacent curb stones may be provided.

It is clear that one or more features of one of the aspects of the invention may be combined with one more or all features of one or more other aspects of the invention.

### BRIEF DESCRIPTION OF THE DRAWINGS

FIG. 1 to FIG. 5 and FIG. 7 illustrate schematically powerline carriers according to the invention.

FIG. 6 schematically illustrates powerline carriers according to the invention, which are composed of a kit of parts according to the present invention.

FIG. 8 schematically shows a transverse cross section of a powerline carriers according to the invention, which are composed of a kit of parts according to the present invention, where the curb stone insert and the curb stone addon of the kit of parts is visible.

FIG. 9 schematically shows a transverse cross section of the powerline carrier of FIG. 8, at a location where the powerline carrier cross section is composed of a kit of parts according to the present invention, where the curb stone insert and the curb stone coverup of the kit of parts is visible.

FIG. 10 shows schematically a longitudinal cross section of the powerline carrier according to the plane BB′ of FIG. 8.

FIG. 11 shows schematically the powerline carrier shown in FIG. 9 in an installed curb.

FIG. 12 shows schematically a powerline carrier according to the fourth aspect of the invention.

FIG. 13 shows schematically a curb stone according to the fifth aspect of the invention, adapted to receive the powerline carriers of FIG. 12.

FIG. 14 shows schematically the curb stone according of FIG. 13, adapted to receive the powerline carriers of FIG. 12, adjacent existing curb stones in which a wedge is provided. In the wedge, curb stone coverups according to the fourth aspect of the invention are provided.

FIG. 15 shows schematically another curb stone according to the present invention, adapted to receive the powerline carriers, adjacent existing curb stones in which a wedge is provided. In the wedge, curb stone coverups according to the fourth aspect of the invention are provided. The two power line carriers are shown as a housing comprising one power point being removed from the elongate volume.

FIG. 16 shows schematically another curb stone according to the present invention.

In the different figures, the same reference signs refer to the same or a similar feature.

### DETAILED DESCRIPTION OF EMBODIMENT(S)

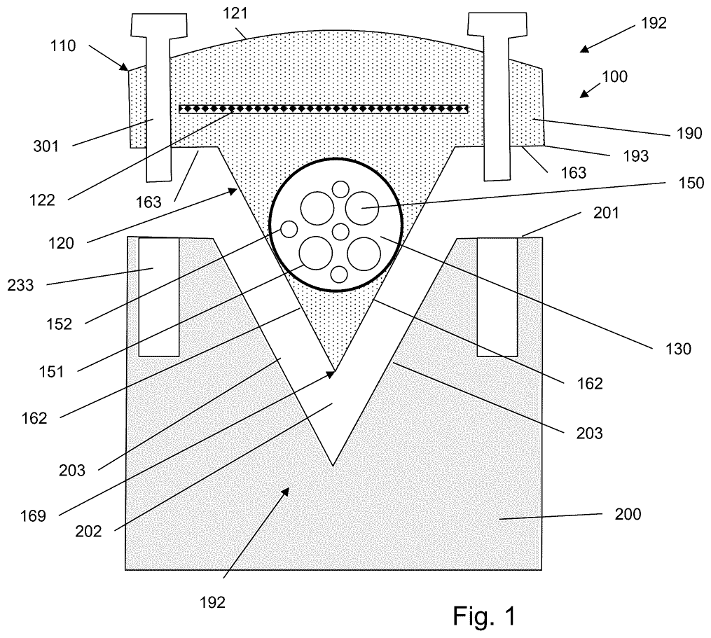

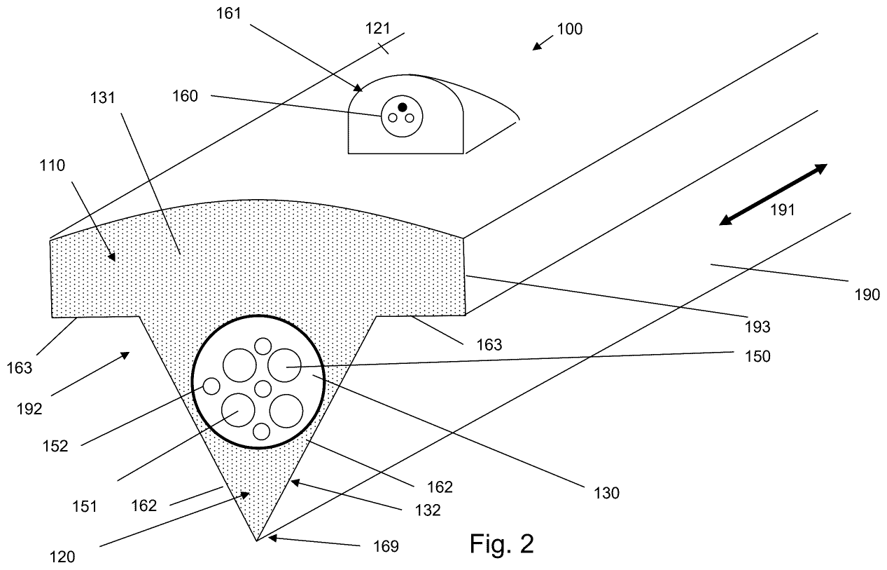

A powerline carrier 100 which is adapted to carry powerlines 150 on one or more curb stones according to the first aspect of the invention is showing in FIG. 1. A traverse cross section of a powerline carrier 100 which is adapted to carry powerlines 150 on one or more curb stones according to the first aspect of the invention is showing in FIG. 2. The powerline carrier comprises an elongate volume 190, elongate in a longitudinal direction 191 and having a transverse cross section 192, shown in FIG. 1, adapted to be partially sunken in one or more curb stones 200. The circumference 193 of the transverse cross section 192 comprises a first part 110 adapted to contact the one or more curb stones. The transverse cross section 192 also comprises a second part 120 defining the curved outer side 121 of the powerline carrier 100 oriented away from the one or more curb stones 200. The powerline carrier 100 comprises at least one housing 161 for holding at least one, optionally only one power point 160, which power point 160 is accessible at the outer side 121 of the powerline carrier 100. The volume 190 comprises at least a first tubular channel 130 extending in the longitudinal direction and has one outer end 131 near or at one of the transverse sides 132 of the volume 190. This first tubular channel 130 is adapted to hold one or more power cables 151 in the longitudinal direction 191 of the powerline carrier 100. The cables and/or wires are provided in the first tubular channel 130 between one of the transverse sides 132 of the volume 190 and the housing or housings 161.

As shown in FIG. 1, the powerline carrier 100 may be provided with holes 300 for receiving bolts 301, the bolt being adapted to placed and hold the powerline carrier 100 to the to surface 201 of the curb stones 200. The bolts are bolted into sleeves inserted in holes 233 made in the curb stones 200.

In the embodiment in FIGS. 1 and 2, the powerline carrier 100 is made of one integral part made out of rubber or polymer. In the upper, second part 120, a reinforcing means, like a textile nonwoven or woven fiber tissue, e.g. a glass fiber or filament woven fabric 122 may be provided. Four power lines 150, being four power cables 151 are provided in the first tubular channel 130, together with four data carrying cables 152.

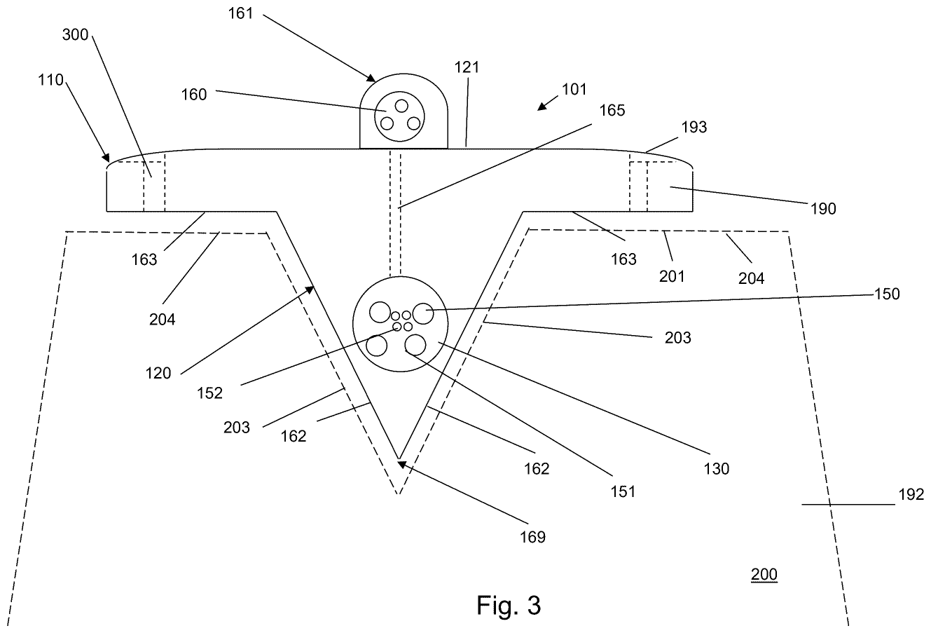

FIG. 3 shows a further view of a traverse cross section of a powerline carrier 101 which is adapted to carry powerlines 150 on one or more curb stones according to the first aspect of the invention. The same reference signs refer to similar or identical elements and features as described for the powerline carrier 100 in FIG. 1. A pass through opening 165, here a tubular opening, for conducting at least one power cable between the first tubular channel 130 and the housing 161 is provided.

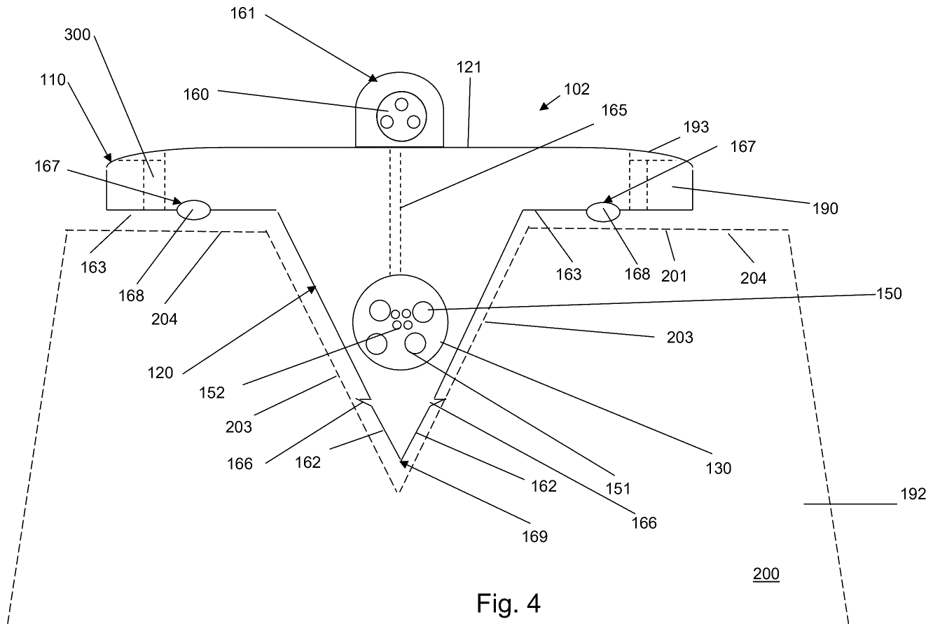

FIG. 4 shows a further view of a traverse cross section of a powerline carrier 102 which is adapted to carry powerlines 150 on one or more curb stones according to the first aspect of the invention. The same reference signs refer to similar or identical elements and features as described for the powerline carrier 100 in FIG. 1. A pass through opening 165, here a tubular opening, for conducting at least one power cable between the first tubular channel 130 and the housing 161 is provided.

At the lower side of first part 110 of the circumference 193 of the transverse cross section 192, barbs 166 are provided, which may prevent the powerline carrier 102 to be pulled upward easily out of the wedge, also referred to as recess, made in the curb stones, in which a part of the first part 110 of the circumference 193 of the transverse cross section 192 is sunken. The circumference 193 of the transverse cross section 192 is provided with two stuffing boxes 167, one at each lateral side of the powerline carrier 102, for holding a seal 168 to be provided between the first part 110 and the surface 201 of the curb stone or stones 200.

In FIGS. 1, 2, 3 and 4, the surface 201 of the curb stone or stones 200 oriented upwards the curb stone, is substantially flat and horizontal. A V-shaped recess 202 is provided in the surface of the curb stone, which can be provided fairly easily by grinding two cuts 203, one cut along one of the legs of the V-shaped recess. At the upper side of the surface 201, two substantially horizontal planes 204 are provided. The lower side of first part 110 of the circumference 193 of the transverse cross section 192, ends at an apex 169. The part of the first part 110 of the circumference 193 of the transverse cross section 192 being sunken in the V-shaped recess 202, hence has a V-shaped form, defined by the apex 169, two upwards flanks 162 and two substantially horizontal flanks 163.

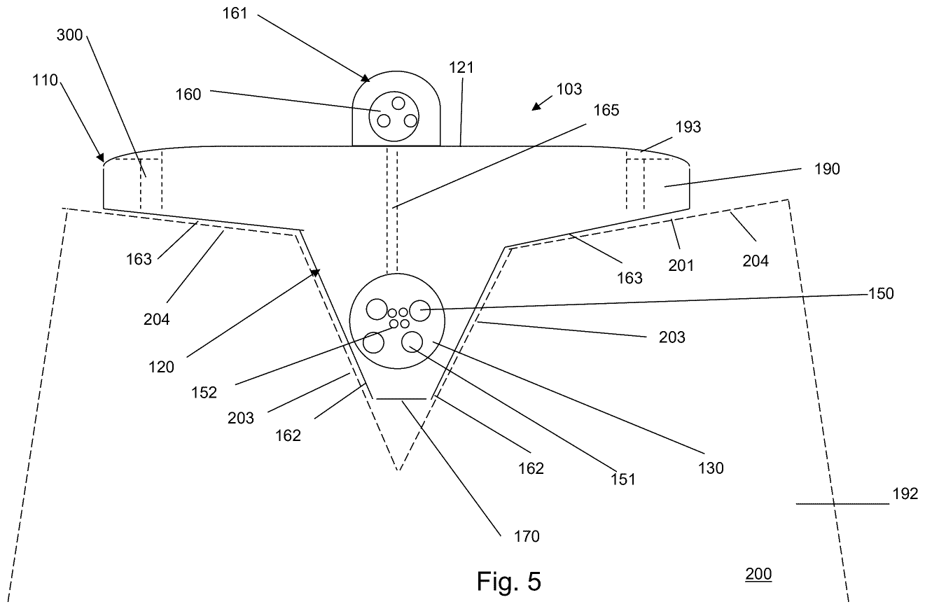

FIG. 5 shows a further view of a traverse cross section of a powerline carrier 103 which is adapted to carry powerlines 150 on one or more curb stones according to the first aspect of the invention. In this embodiment, the two flanks 162 are not coinciding at an apex, but the flanks 162 being truncated by a lower flank 170. The two flanks 163 are not horizontal but inclined downwards. At the upper side of the surface 201 of the curb stone, two inwards inclined planes 204 are provided, e.g. by grinding.

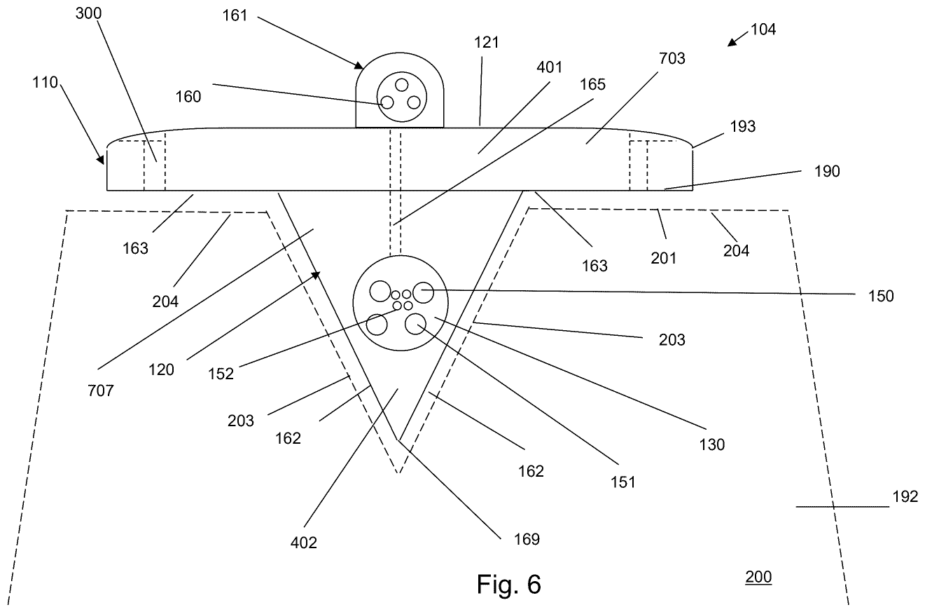

For all the embodiments shown in FIG. 1 to 5, as well as the embodiments in FIGS. 6 to 8, the two flanks 162 and the two flanks 163 provide a first pair of a first segment (being each of the flanks 162) and a second flank (being the respective adjacent flank 163), for which the angle between the first and second segment is equal to or more than 90° and less than 180°. The volume of the powerline carrier may be provided from polymer, like extruded or mould injected polymer, optionally recycled polymer, like hard PVC, PE, PP, HDPE, HDPP, epoxy or composite or rubber. The power lines may be provided with plugs and/or sockets (not shown in the figures) to allow a power line from one powerline carrier to be electrically connected to a power line of an adjacent powerline carrier.

FIG. 6 shows a further view of a traverse cross section of a powerline carrier 104 which is adapted to carry powerlines 150 on one or more curb stones according to the first aspect of the invention. The powerline carrier 104 comprises a first, upper portion 401 and a second, lower portion 402, together forming the powerline carrier 104. The first, upper portion 401 provides a curb stone addon 703 according to the 4th aspect of the invention. The second, lower portion 402 provides a curb stone insert 707 according to the 3rd aspect of the invention. Together the first and second portion form a powerline carrier 104. This first, upper portion 401 and a second, lower portion 402 together form a kit of parts according to the 2nd aspect of the invention. The first, upper portion 401 and a second, lower portion 402 being connected, e.g. glued or welded one to the other, together form a powerline carrier 104 which may be similar, even identical to the powerline carrier 101 of FIG. 3.

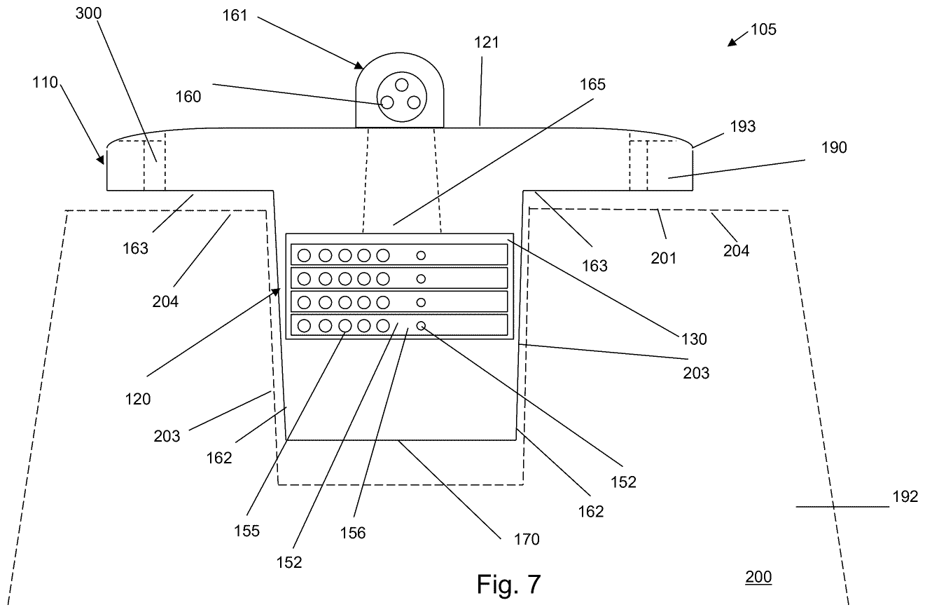

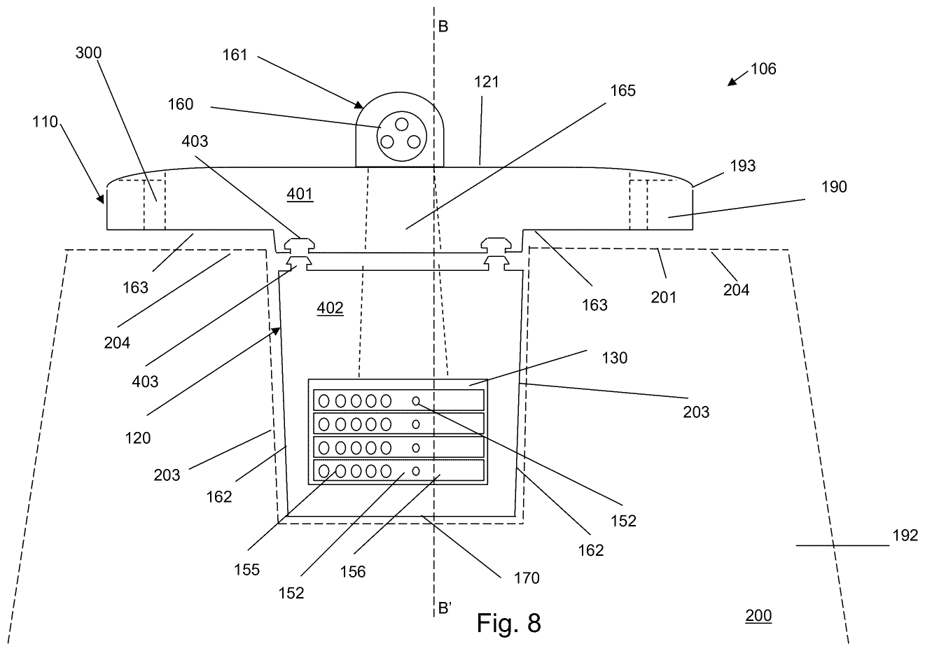

In the embodiments shown in FIGS. 1 to 6, the tubular channel 130 is provided as a substantially circular tubular channel. In the embodiments shown in FIGS. 1 to 6, as well as the embodiment in FIGS. 7 to 8, this cross section may also be different than circular, like elliptic, rectangular, square even triangular of polygonal. The tubular channel 130 may be provided during the provision of the powerline carrier, e.g. when polymer or rubber is extruded. The tubular channel may as well be provided by introducing a tube, e.g. a polymer or steel tube, with the given cross section in the volume of the powerline carrier, or the rubber or polymer being extruded or cases around the tube.

In the embodiments shown in FIGS. 1 to 6, in each case four power cables 151 and four data carrying cables 152 are shown. In the embodiments shown in FIGS. 1 to 6, as well as the embodiment in FIGS. 7 to 8, the number of power cables 151 and/or data carrying cables 152 may be different from four, like 1, 2, 3, 4, 5, 6, 7, 8 9, 10 or even more. The number of power cables 151 may be identical or different from the number of data carrying cables 152. The number of power cables 151 and/or data carrying cables 152 may be identical to or different from the number of power points 160 being accessible at the outer side 121 of the powerline carrier. The housings 160 may be provided with a closing lid or cover (not shown in FIGS. 1 to 8), to close the housing when the power point is not used or is not in use, and/or to prevent access to the power point when closed. Between the housing and the cover or lid, a lock may be provided, which may be controlled by means of one or more of the data carrying cables in the powerline carrier.

The power cables each may carry a plurality of electrical conductors, mutually electrically insulated one from the other. Also the data carrying cables each may carry a plurality of electrical conductors, mutually electrically insulated one from the other.

FIG. 7 shows a view of a traverse cross section of another powerline carrier 105 which is adapted to carry powerlines 150 on one or more curb stones according to the first aspect of the invention. This powerline carrier 105 is provided from one entire volume. The flanks 162 and 163 make an angle of 90° or more, e.g. up to 100° or 110°, while at the lower side, the flanks 162 are delimited and truncated by a lower flank 170. As such the part inserted in a recess in the curb stone has about a trapezoid shape. Also the recess in the curb stone has a trapezoid, similar shape. In the lower part of the volume, a rectangular tubular channel 130 is provided, in which four flat power lines 150 are provided. Each power line comprises 5 electrical conductors 155, which may be metal wires or cables, being mutually electrically insulated by an electrically insulating material 156. In the power lines, a data carrying cable 152 is embedded, which itself may comprise a plurality of mutually electrically separated electrical conductors, each being a wire of a cable. These flat power lines 150 may be staked one onto the other.

FIG. 8 shows a view of a traverse cross section of another powerline carrier 106 which is adapted to carry powerlines 150 on one or more curb stones according to the first aspect of the invention. This powerline carrier 106 comprises a first, upper portion 401 and a second, lower portion 402, together forming the powerline carrier 104. This first, upper portion 401 and a second, lower portion 402 together form a kit of parts according to the second aspect of the invention. The first, upper portion 401 and a second, lower portion 402 being provided with snap connectors 403 to connect both portions. Further connection means, like e.g. glue, may be provided to connect the two portions. The two portions together form a powerline carrier 106 which may be similar, even identical to the powerline carrier 105 of FIG. 7.

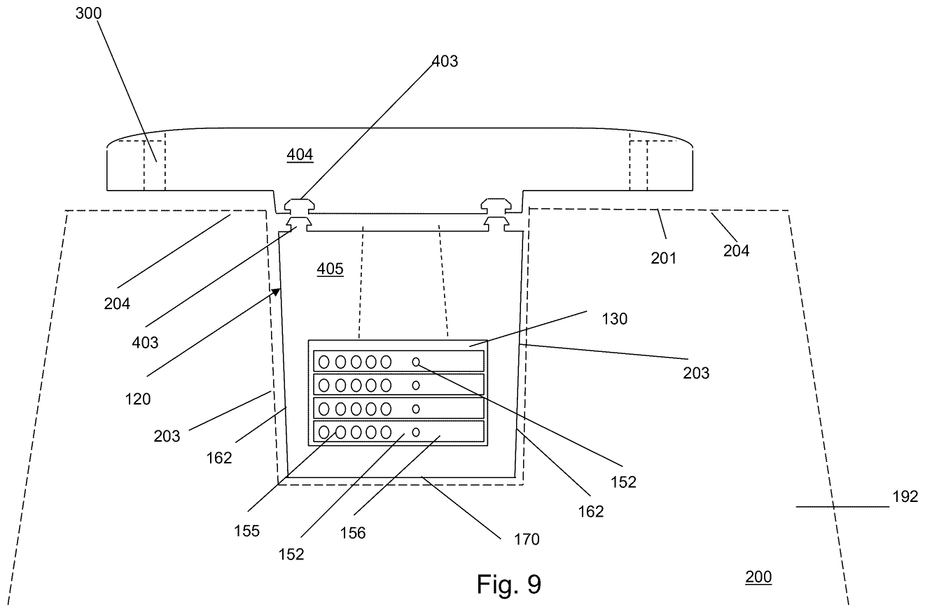

FIG. 9 shows a view of a traverse cross section of a curb stone coverup 404 according to the 4th aspect of the invention. The cross section is similar to the cross section of the curb stone addon of FIG. 8, however the curb stone coverup 404 is free of a housing to receive a power point. This curb stone coverup 404 may be combined with a curb stone insert 405, which is identical to the lower, second portion 402 of the powerline carrier 106 of FIG. 8.

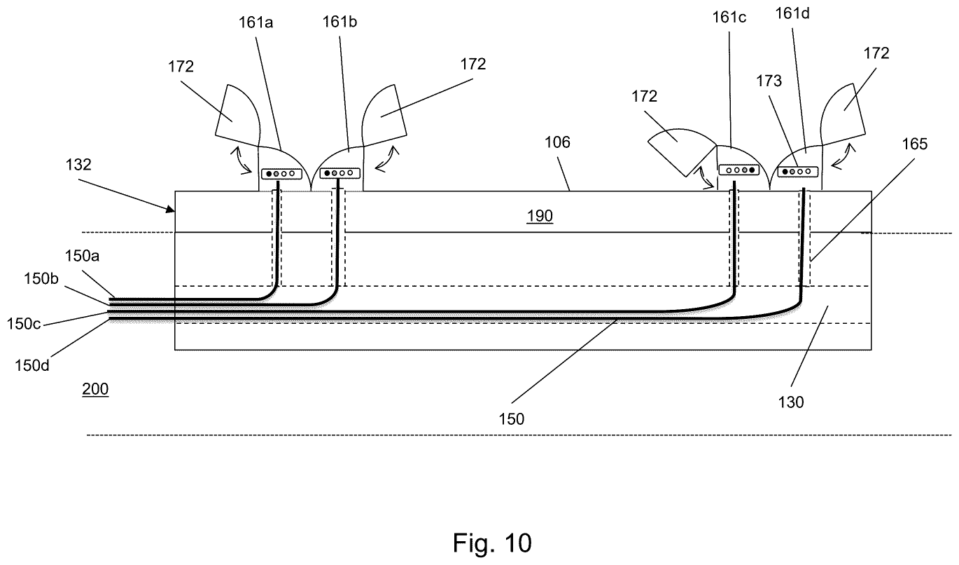

FIG. 10 shows a longitudinal cross section of the powerline carrier 106 according to the plane BB′. Four power points are provided, in two pairs of two power points, each power point houses in a housing 161a, 161b, 161c and 161d. Each housing is closable by means of a closing lid 172 which is hingedly connected to the housing and can be watertight closed and optionally locked. Each housing 161a to 161d is also provided with a set of tell-tale lights 173, which may indicate the status of the power point in the housing. The tell-tale lights 173 and the lock on the closing lid 172, if provided, may be controlled by the control signals provided by the data carrying cable of the powerlines 150.

In the tubular channel 130 of the powerline carrier 106, the four power lines 150a, 150b, 150c and 150d are provided in this tubular channel between the transverse side 132 of the volume 190 and one of the housing 161 a to 161 d. The power line 150a being the upper power line in the stack of four power lines, extend from the transverse side 132 via the tubular channel 130 and the pass through opening 165, up to and into the housing 161a. Hence the upper positioned power line extends from the transverse side 132 via the tubular channel 130 and the pass through opening 165 to the power point and the accompanying housing being closest to the transverse side. The power line 150b being the next power line from top to bottom in the stack of four power lines, extend from the transverse side 132 via the tubular channel 130 and the pass through opening 165, up to and into the housing 161b. Hence the next power line from top to bottom in the stack of four power lines, extend from the transverse side 132 via the tubular channel 130 and the pass through opening 165 to the power point and the accompanying housing being in the next position positioned from the transverse side in the direction and sense away from the transverse side 132. The power line 150d being the lowermost power line in the stack of four power lines, extend from the transverse side 132 via the tubular channel 130 and the pass through opening 165, up to and into the housing 161d. Hence the lowermost positioned power line extends from the transverse side 132 via the tubular channel 130 and the pass through opening 165 to the power point and the accompanying housing being most far positioned from the transverse side. This ordering of the position of power lines and the housings coupled to each of them, allows a smooth and easy coupling without power lines being mixed up or crossing each other.

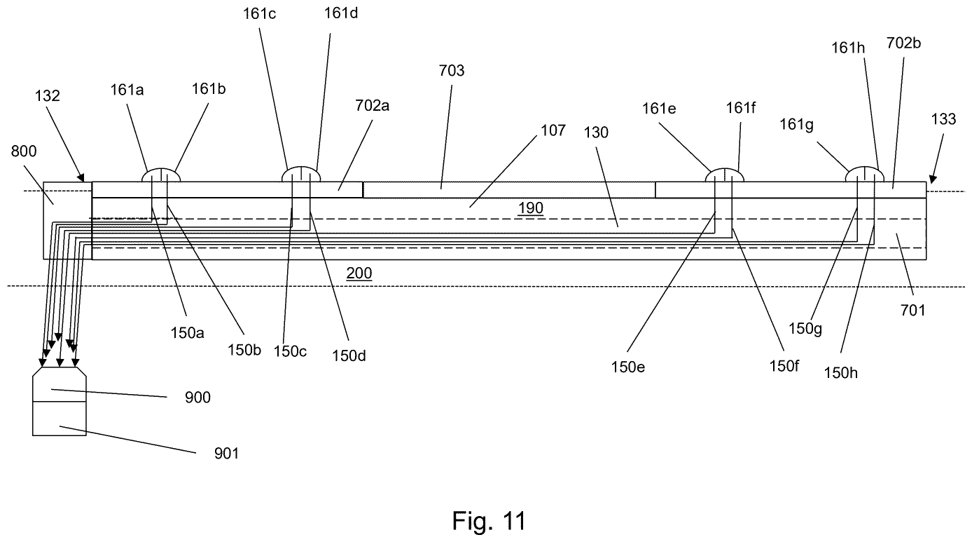

In another embodiment of a powerline carrier 107, one curb stone insert 701, similar to the curb stone insert 401 shown in FIG. 9, is provided and shown in FIG. 11. The powerline carrier 107 in this case comprises eight housings and eight power points 161a to 161h.

The curb stone insert 701 comprises eight stacked power lines 150a to 150h, ordered and stacked such that a next power line from top to bottom in the stack of four power lines, extend from the transverse side 132 via the tubular channel 130 to the housing being in the next position positioned from the transverse side in the direction and sense away from the transverse side 132. The outer, for the user and once installed visible side of the powerline carrier 107, is comprises two curb stone addons 702a and 702b identical the curb stone addon shown of FIG. 8. The two curb stone addons 702a and 702b are connected the curb stone insert 701 and in lateral direction mutually spaced by a curb stone coverup 703, being identical to the curb stone coverup 403 as shown in FIG. 9. At the transverse side 132, a bend element 800 is provided, in order to allow the power lines 150a to 150h to bend towards a side of the road or field from which the curb is part of, and thereby allows the power lines 150a to 150h to be electrically coupled to the power grid via a distribution means 900, like a distribution box. The data cables may also be connected to a control means 901, thereby allowing to control, based amongst others upon the data obtained via the data cables, the distribution of electrical power to one or more of the power points. These control means 901 and distribution means 900 may be housed in one and the same cabinet. The opposite transverse side 133, an end piece element 801 may be provided to amongst others close the tubular channel 130 if this channel also debouches at this second transverse side 133.

A method to install these powerline carriers, hence a method to provide integrated power points to a curb, comprises the provision of a curb having one or more than one adjacent curb stones. The curb stone or stones may be grinded or milled, to provide a wedge or recess on the top surface of the curb stone or stones, facing upwards. The first part of the powerline carrier, optionally being only the curb stone insert portion, is inserted and connected, e.g. glued to the sides of the curb stone or stones to be contacted. In case the powerline carrier is provided as a kit of parts, the curb stone addon or addons, and optionally the curb stone coverups, are connected to the curb stone insert. During the execution of these steps, or after having executed these steps, power points are coupled to the power lines, and these power points are provided in the corresponding houses.

In a similar way, the powerline carriers may as well be installed in a similar or identical way, in sides or surfaces of the curb stone being provided above the ground level, e.g. in side-surfaces or surfaces being non horizontal, e.g. inclined versus the horizontal.

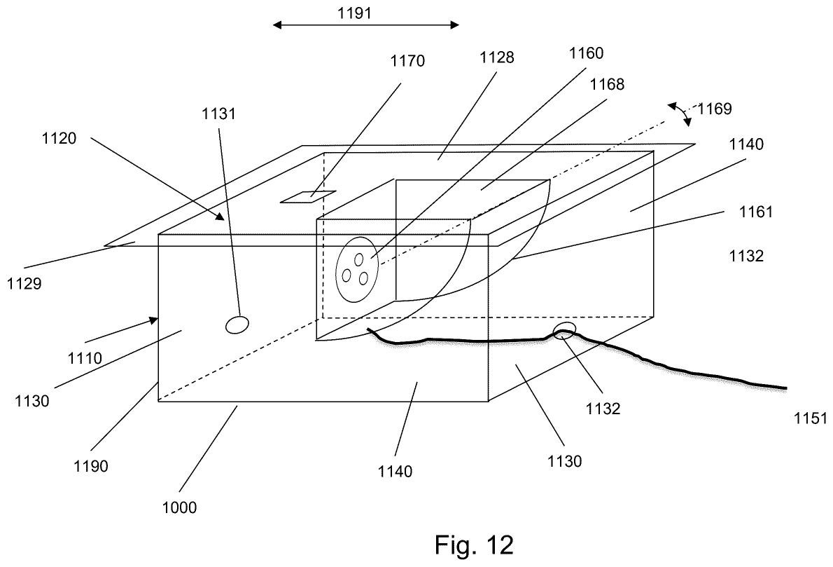

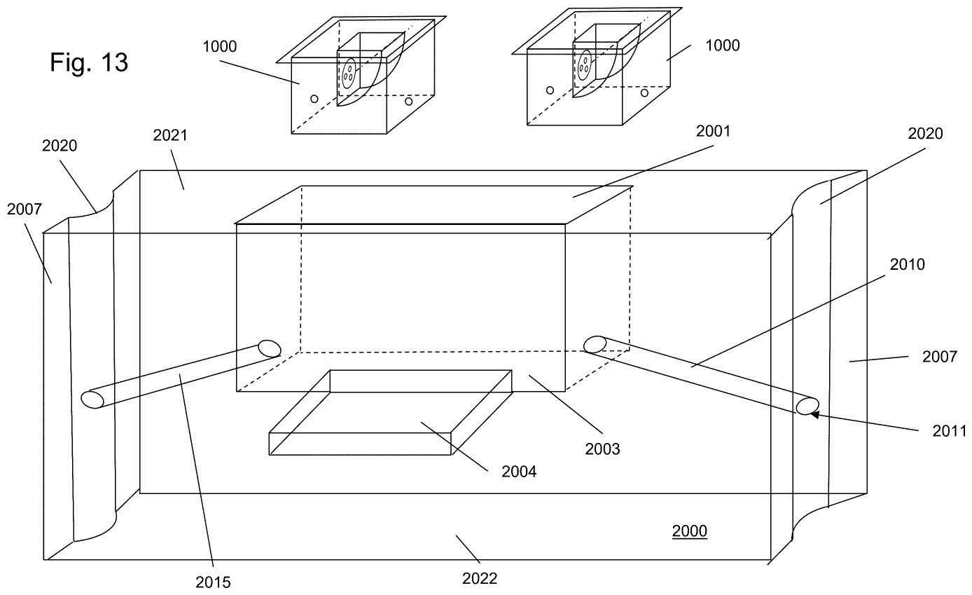

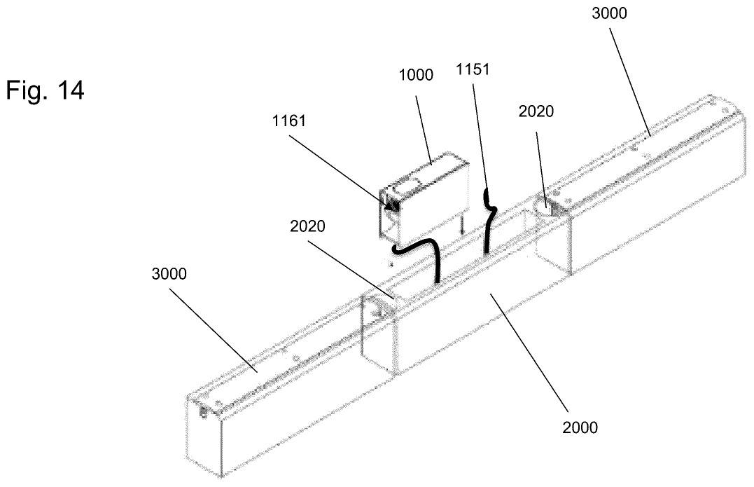

FIG. 12 shows a power line carrier 1000, which comprises an elongate volume 1190, elongate in a longitudinal direction 1191 and having a transverse cross section adapted to be at least partially sunken in a curb stone. The elongate volume is a stainless steel box being provided with a flange 1129. The first part 1110, i.e. the lower, lateral 1140 and traverse walls or sides 1130 of the volume 1190, is adapted to be sunken in a curb stone 2000, as shown in FIGS. 13 and 14. The second part 1120, in this embodiment the flange 1129 and the upper closing lid 1128, defines the outer side of the powerline carrier, i.e. the side oriented away from the curb stone.

The powerline carrier 1000 comprises one housing 1161 for holding at least one, and in this embodiment one power point 1160. The power point 1160 is accessible at the outer side of the powerline carrier 1000 when the housing is in a first rotational position (not show in in FIG. 12). Starting from the second rotational position as shown in FIG. 12, the housing is to rotate 90°, in this embodiment and view in FIG. 12, in clockwise direction around the rotation axis 1169 in order to bring the power point 1160 above the level of the flange 1129 and the upper closing lid 1128. A side 1168 of the housing 1161 completes the top or upper surface of the powerline carrier 1160 when the housing is in its second rotational position as shown in FIG. 12. Between the upper closing lid 1128 and the circumference of the side 1168, a sealing is provided to watertight close the rim of the side 1168 while being in the second rotational position.

A first entrance 1131 and a second entrance 1132 in the volume is provided, one at each of the transverse sides 1131 of the volume. These first entrances 1131 and 1132 are both adapted to receive one or more power cables at the transverse sides 1130 of the volume 1110. At least one, and possibly more than one power cables 1151 is provided in the entrance 1131 between the transverse side 1130 of the volume and the housing 1161, to provide electrical current and power to the power point 1160.

In an alternative embodiment, one or more entrances are provided in the volume, near the transverse sides of the volume in the bottom wall of the volume.

At the upper closing lid 1128 or the side 1168, an identification means 1170, like a barcode or QR code may be made available to identify the power point 1160 in the housing adjacent the identification means.

FIG. 13 shows schematically a curb stone 2000, adapted to receive in this embodiment two powerline carriers 1000 of FIG. 12.

FIG. 14 shows schematically the curb stone according of FIG. 13, adapted to receive the powerlines carriers of FIG. 12, adjacent existing curb stones in which a wedge is provided. In the wedge, curb stone coverups according to the fourth aspect of the invention are provided.

The curb stone 2000 is adapted to receive two powerline carrier 1000, one adjacent the other in longitudinal direction 1191 of volumes of the powerline carriers 2000.

The curb stone 2000 comprises a recess 2001 for having the elongate volumes 1000 of the powerline carriers to be at least partially sunken in this recess 2000.

At one or, as shown in FIGS. 13 and 14, at both traverse sides 2007, the curb stone 2000 comprise a tubular channel 2010 and 2015 extending in longitudinal direction between the traverse side 2007 of the curb stone 2000 and the recess 2001. This or these tubular channels are adapted to hold one or more power cables.

At the bottom 2003 of the recess 2001, at least one, and in this embodiment one drain hole 2004 is provided, which is adapted to conduct fluids, like rainwater, from the recess 2001 through the outer wall of the curb stone towards ambient. This drain hole hence debouches at the side of the curb stone 2000 which will be oriented towards the path, street or lane of which the curb stone is part of the curb, and will debouch above the path, street or lane level. The curb stone 2000 has a cavity 2020 oriented inwards the curb stone and extending from the top side 2021 of the curb stone at least up to the outer end 2011 of the tubular channels 2010 or 2015 present at the one of the traverse sides 2007. In this embodiment the cavity 2020 is oriented inwards the curb stone and extends from the top side 2021 of the curb stone to the bottom side 2022 of the curb stone. This cavity can be used to manipulate and install the power and other cables 3001 which are extending from the adjacently installed curb stone coverups 3000, in the tubular channels 2010 and further through the entrances 1130 or 1131 to the housing 1161. In FIG. 14, the side wall of the volume 1161 is removed for clarity.

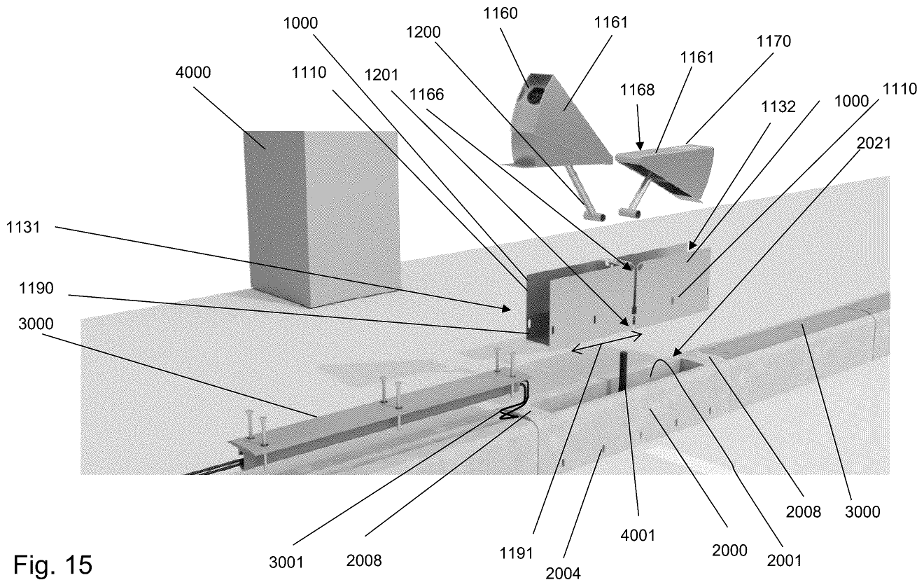

FIG. 15 shows schematically a curb stone 2000, adapted to receive two power line carriers 1000, which comprises an elongate volume 1190, elongate in a longitudinal direction 1191. The elongate volume is a stainless steel U-shaped volume.

The powerline carrier 1000 comprises one housing 1161 for holding at one power point 1160. The power point 1160 is accessible at the outer side of the powerline carrier 1000 when the housing is in a first rotational position as shown for the left hand power point in FIG. 15. A power point 1160 may be hidden from the outer side of the powerline carrier 1000 when the housing is in a second rotational position as shown for the right hand power point in FIG. 15. Switching between the two rotational positioned may be done by activating the gas spring 1200. This gas spring is rotationally fixed at the lower side of the 1190, at point 1201. Staring from the power point in the second rotational position, by activating the gas spring, the spring will elongate and push the housing upwards, causing this housing to rotate round its point and axis of rotation 1166,being located at the upper side of the volume. as such the housing will rotate around the axis of rotation and bring the power point 1160 to an accessible position, i.e. the first rotational position. It is understood that this rotation system may be used in combination with any powerline carrier according to the invention. Similarly, it is understood that other rotation systems adapted to rotate the housing or housings of powerline carriers, may be used.

A side 1168 of the housing 1161 completes the top or upper surface of the powerline carrier 1160 when the housing is in its second rotational position as shown in FIG. 15 at the right hand. Between the upper closing lid 1128 and the circumference of the side 1168, a sealing is provided to watertight close the rim of the side 1168 while being in the second rotational position.

A first entrance 1131 and a second entrance 1132 in the volume is provided, one at each of the transverse sides 1131 of the volume by providing open transversal sides. These first entrances 1131 and 1132 are both adapted to receive one or more power cables at the transverse sides 1130 of the volume 1110. At least one, and possibly more than one power cables 3001 is provided in the entrance 1131 between the transverse side 1130 of the volume and the housing 1161. Further, power cables 4001 are connected to the electrical grid at the control cabinet 4000. The power and data cables 4001 are provided under the sidewalk 5000, into the curb stone 2000. Further power cables 3001 may provide to conduct electrical current and power to adjacent power points in adjacent curb stone, via installed curb stone coverups 3000.

At the side 1168, an identification means 1170, like a barcode or QR code may be made available to identify the power point 1160 in the housing adjacent the identification means.

FIG. 15 shows schematically the curb stone 2000, adapted to receive, adjacent existing curb stones in which a wedge is provided. In the wedge, curb stone coverups according to the fourth aspect of the invention are provided.

The curb stone 2000 is adapted to receive two powerline carrier 1000, one adjacent the other in longitudinal direction 1191 of volumes of the powerline carriers 2000.

The curb stone 2000 comprises a recess 2001 for having the elongate volumes 1000 of the powerline carriers to be at least partially sunken in this recess 2000.

At both traverse sides of the curb stone, the curb stone has cavities from the top side 2021 of the curb stone downwards. These cavities can be used to manipulate and install the power and other cables 3001 which are extending from the adjacently installed curb stone coverups 3000, in the tubular channels 2010 and further through the entrances 1130 or 1131 to the housing 1161. The upper side of the cavities may be closed by a closing part 2008 of the curb stone. Alternatively, the upper side of the cavities may be open, and provided with a closing lid to close the upper side of the cavities when the curb stone is in use.

At the bottom of the recess 2001, at least one, and in this embodiment some drain holes 2004 are provided, which are adapted to conduct fluids, like rainwater, from the recess 2001 through the outer wall of the curb stone towards ambient. This drain hole hence debouches at the side of the curb stone 2000 which will be oriented towards the path, street or lane of which the curb stone is part of the curb, and will debouch above the path, street or lane level.

Hence this curb stone 2000 provides a curb stone 2000 according to the tenth aspect of the invention. A curb stone has a volume, such as a concrete volume or body, having one recess 2001 accessible from the upper side of the curb stone. The curb stone comprises two power point retaining means, also referred to as power line carriers 1000, each for holding one power point. The power point retaining means is provided as a housing 1161 which can be rotated along the axis by a spring 1200. The power point retaining means being substantially completely sunken in the recess. At the lower side of the power point retaining means, between the lower side of the power point retaining means and the bottom of said recess, a void volume is provided, wherein the curb stone 2000 comprises a plurality of drain hole 2004 adapted to conduct fluids, like rainwater, from the void volume at the bottom of the recess through the outer wall of the curb stone towards ambient.

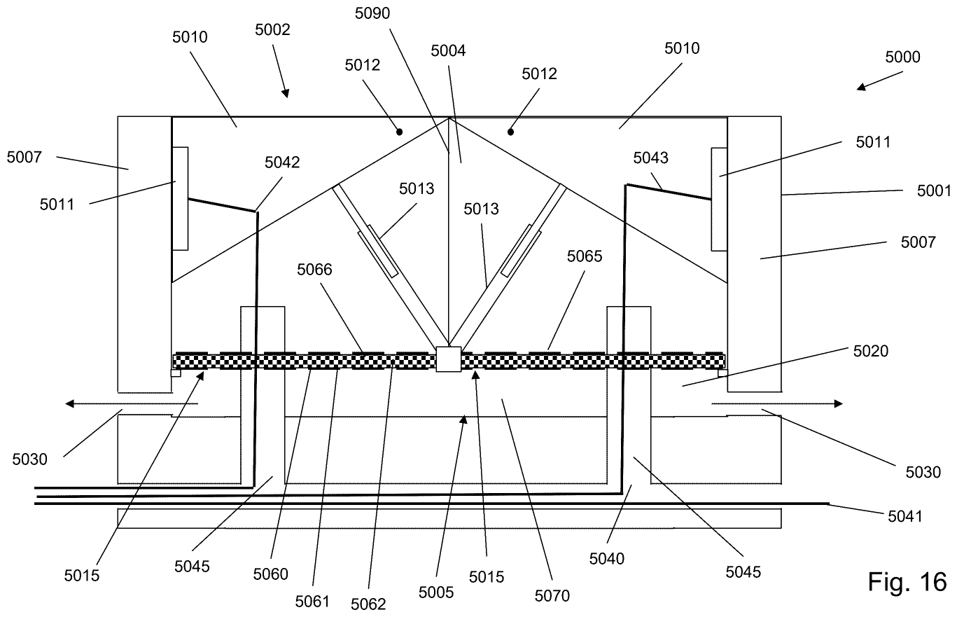

FIG. 16 shows another curb stone 5000 according to the tenth aspect of the invention. A curb stone 5000 having a volume 5001, such as a concrete volume or body, having one recess 5004 accessible from the upper side 5002 of the curb stone. The curb stone comprises two power point retaining means 5010, also referred to as power line carriers, each for holding one power point 5011. The power point retaining means is provided as a housing which can be rotated along the axis 5012 by a spring 5013. The two power point retaining means 5010 are separated by walls 5090. The power point retaining means being substantially completely sunken in the recess. At the lower side of the power point retaining means 5010, between the lower side 5015 of the power point retaining means and the bottom of said recess 5005, a void volume 5020 is provided, wherein the curb stone 5000 comprises two drain hole 5030 adapted to conduct fluids, like rainwater, from the void volume 5020 at the bottom of the recess through the outer transverse wall 5007 of the curb stone towards ambient.

Under the void volume 5020, under the bottom 5005 of the recess 5004, a channel 5040, being a second tubular channel, is provided extension between in lateral direction between the two transverse walls 5007 of the curb stone volume 5001. In this channel a plurality of power lines 5041, 5042 and 5043 are provided, three of which are shown in FIG. 16. A first power line 5041 extends through the channel 5040 and is to connect the power points of an adjacent curb stone to the power grid or to a power station or alike. Both power lines 5042 and 5043 are to couple one of the two power points 5011 to the power grid or to a power station or alike. Optionally a data cable (not shown in FIG. 16) follows the same track. To access the recess 5004, the channel 5040 has two branches 5045, one for each power line 5042 and 5043, extending upwards in the recess 5004.

Above the two drain holes 5030, a water permeable object retaining surface 5060 is provided. This water permeable object retaining surface 5060 is provided by a water permeable envelope 5061 made from metal wire grid, filled with solid objects, such as crushed stone 5062. Fluid, like rainwater and dirt seeping into the recess will flow down this water permeable object retaining surface 5060. The dirt will be held by the water permeable envelope 5061 filled with crushed stone 5062. The water will pass through the water permeable envelope 5061 filled with crushed stone 5062. As such the water will be provided to a second channel 5070, defining the void volume 5020, in the curb stone, which passes the water to one or both the drain holes 5030. The outer ends of the two branches 5045 extends through the water permeable object retaining surface 5060 and end well above the water permeable object retaining surface 5060. As shown in FIG. 16, the water permeable object retaining surface 5060 may be provided as tiles, e.g. in two parts 5065 and 5066. Upon maintenance of the curb stone, the two power point retaining means 5010 may be lifted out of the recess 5004, providing access to the in two parts 5065 and 5066 of the water permeable object retaining surface 5060. The water permeable object retaining surface 5060 may be cleaned, and dirt collected on or in the water permeable object retaining surface 5060 may be removed. Possibly the water permeable object retaining surface 5060 may be taken out of the recess 5004 as well during cleaning.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein. In other words, it is contemplated to cover any and all modifications, variations or equivalents that fall within the scope of the basic underlying principles and whose essential attributes are claimed in this patent application. It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1. A curb stone having a volume, said volume having at least one recess accessible from the upper side of the curb stone, the curb stone comprises:
at least one power point retaining means for holding at least one, said power point retaining means being at least partially sunken in said at least one recess, between the lower side of said at least one power point retaining means and the bottom of said recess, at least one void volume is provided,
wherein said curb stone comprises at least one drain hole adapted to conduct fluids from the void volume at the bottom of the recess through the outer wall of the curb stone out of said volume.

2. The curb stone according to claim 1, wherein said at least one power point retaining means has at least one opening at the lower side of the said at least one power point retaining means.

3. The curb stone according to claim 1, wherein the curb stone further comprises a first tubular channel adapted to hold one or more power cables between the outer side of the volume and said recess.

4. The curb stone according to claim 3, wherein said first tubular channel is a channel positioned adjacent or under the void volume at the bottom of the recess.

5. The curb stone according to claim 1, wherein the volume of the curb stone is an elongate volume, elongate in a longitudinal direction.

6. The curb stone according to claim 5, wherein the at least one recess is an elongate recess, elongate in said longitudinal direction of said volume.

7. The curb stone according to claim 5, wherein at least a first and a second drain hole is provided, one at each traverse side of the volume.

8. The curb stone according to claim 5, wherein at least a first drain hole is provided, at one lateral side of the volume.

9. The curb stone according to claim 1, wherein under the lower side of said at least one power point retaining means and spaced apart from the bottom of said recess, a water permeable object retaining surface is provided.

10. The curb stone according to claim 9, wherein said water permeable object retaining surface is provided by a metal or polymeric grid, a perforated plate or a filter system comprising a water permeable envelope, filled with solid objects, such as crushed stone, biodegradable objects or alike.

11. The curb stone according to claim 1, wherein the curb stone further comprise a second tubular channel extending between two mutually opposite sides of the volume of the cube stone, preferably the traverse sides of the volume, said second tubular channel providing two drain holes adapted to conduct fluids, like rainwater, from the void volume at the bottom of the recess through the outer wall of the curb stone towards ambient

12. The curb stone according to claim 1, wherein said at least one power point is rotatable in said power point retaining means between at least a first position and a second position, said power point when being in the first rotational position, is adapted to provide the power point accessible at the outer side of the curb stone, said power point being in the second rotational position, said the power point being hidden from access from the outer side of the curb stone.

13. The curb stone according to claim 12, wherein the axis or axes of rotation of the rotational power point are perpendicular to the longitudinal direction of the curb stone and parallel to the upper side of the curb stone.

14. The curb stone according to claim 1, wherein power point retaining means comprises at least a flange for contacting the top side of the curb stone when the power point retaining means is at least partially sunken in said recess.

15. A method for providing integrated power points to a curb, said method comprising the steps of:
Installing at least one curb stone according to claim 1.

16. A curb comprising a plurality of curb stones according to claim 1.
